(19) United States
(12) Patent Application Publication
(10) Pub. No.: US 2013/0156155 A1
(43) Pub. Date: Jun. 20, 2013

(54) HANDHELD SPECTROMETER

(71) Applicants: Andrew Hession-Kunz, Concord, MA (US); Robert Allard, Andover, MA (US); Jerzy Wilder, Natick, MA (US)

(72) Inventors: Andrew Hession-Kunz, Concord, MA (US); Robert Allard, Andover, MA (US); Jerzy Wilder, Natick, MA (US)

(73) Assignee: i-Nalysis LLC, Concord, MA (US)

(21) Appl. No.: 13/528,282

(22) Filed: Jun. 20, 2012

Related U.S. Application Data
(63) Continuation of application No. 12/567,263, filed on Sep. 25, 2009, now abandoned.
(60) Provisional application No. 61/100,362, filed on Sep. 26, 2008.

(51) Int. Cl. G01N 23/223

(52) U.S. Cl. CPC G01N 23/223
USPC 378/48

(57) ABSTRACT

A handheld X-ray fluorescence spectrometer includes a pyroelectric radiation source for directing X-rays toward a sample to be analyzed and a detector for receiving secondary X-rays emitted from the sample and converting the secondary X-rays into one or more electrical signals representative of the received secondary X-rays. A module is configured to receive the one or more electrical signals and send a representation of the one or more signals over a communication channel to a computing device without performing any spectral analysis on the one or more electrical signals to characterize the sample. The computing device is configured to perform spectral analysis on the one or more electrical signals and send the spectral analysis to the spectrometer over the communications channel.

### CROSS-REFERENCE TO RELATED CASE

This application claims priority to, and the benefit of Provisional U.S. Patent Application Ser. No. 61/100,362, filed Sep. 26, 2008, the entirety of which is incorporated herein by reference.

### TECHNICAL FIELD

The present invention generally relates to the field of spectroscopy including X-ray fluorescence (XRF) spectroscopy and more specifically to performing elemental analysis using a handheld or benchtop XRF spectrometer and analyzer.

### BACKGROUND INFORMATION

Spectroscopy is an analytic technique centered around measuring the interaction (usually the absorption or the emission) of radiant energy with matter and interpreting the interaction both at the fundamental level and for practical analysis. The display of the measured interaction is called a spectrum, that is, a plot of the intensity of emitted or transmitted radiant energy (or some function of the intensity) versus the energy of that light. Interpretation of spectra provides fundamental information on atomic and molecular energy levels, the distribution of species within those levels, the nature of processes involving change from one level to another, molecular geometries, chemical bonding, and interaction of molecules in solution. At the practical level, comparisons of spectra provide a basis for the determination of qualitative chemical composition and chemical structure, and for quantitative chemical analysis.

Spectrometry is the spectroscopic technique used to assess the concentration or amount of a given species. Spectroscopy/spectrometry is often used in physical and analytical chemistry for the identification of substances through the spectrum emitted from or absorbed by them. Types of spectroscopy can be classified by the nature of excitation measured (e.g., electromagnetic, electron beam, acoustic, dielectric, mechanical, etc.) or by the measurement process (e.g., adsorption, emission, or scattering). Common types of spectroscopy include, for example, fluorescence spectroscopy, X-ray spectroscopy, and infrared spectroscopy.

X-ray fluorescence (XRF) spectroscopy is able to perform elemental analysis, or determine the elemental chemistry of a sample, based upon the interaction of elements in a sample with X-rays. Any element in a particular sample, if hit by X-rays of certain energies, will emit a new, wholly different X-ray. These secondary or responsive X-rays are referred to as fluorescent X-rays, and are particular to each element, in the sense of having a unique energy or set of energies, characteristic of the element impinged by the original or primary X-ray.

In practice, the sample is presented to the spectrometer, or the spectrometer to the sample, and the instrument turned on and a test is run for some number of seconds, or until some parameter is met, such as a certain confidence level in the results, or a specific concentration of an element or elements. Generally a safety interlock is used, since ionizing radiation is generated by the instrument. The spectrometer includes an X-ray source, which generates the initial or primary X-rays, and a detector, which is tuned to detect and count the secondary or fluorescent X-rays.

The fluorescent X-rays will each have a specific energy, generally measured in kilo-electron volts (keV). The detector feeds information to a counter system, generally a multi-channel analyzer (MCA) that collects the data for each test by counting the incident X-rays at each energy. The results can be plotted on a chart known as a spectrum. The analysis of this spectrum, generally done by software, provides information on the elemental chemistry of the sample. This analysis software is generally the codification of expert information on the responses of each element or combination of elements, dependent on the matrix or elemental and physical characteristics of the sample. Sophisticated methods of analysis provide known machines with capabilities to determine concentrations of elements with little preparation or preliminary testing.

Elements ranging from Phosphorus to Plutonium are the most common elements detectable with XRF, and some optimization and accessories, such as vacuum interposed between the sample and the detector, can extend the range of detection to lighter elements.

### SUMMARY OF THE INVENTION

It is desirable to provide a new handheld spectrometer that is easily transportable by a single individual. The new spectrometer is simple in construction and less costly than prior art spectrometers, and operation would not require highly skilled users to utilize the spectrometer.

In various exemplary embodiments of the present invention, a handheld or benchtop X-ray fluorescence analysis system is described which utilizes the fact that each element on the periodic table responds to an impinging X-ray with a new X-ray or X-rays of characteristic energy, to identify the elemental make-up of a sample.

A handheld X-ray fluorescence spectrometer according to one aspect of the invention includes a pyroelectric radiation source for directing X-rays toward a sample to be analyzed and a detector for receiving secondary X-rays emitted from the sample and converting the secondary X-rays into one or more electrical signals representative of the received secondary X-rays. A module is configured to receive the one or more electrical signals and send a representation of the one or more signals over a communication channel to a computing device without performing any spectral analysis on the one or more electrical signals to characterize the sample. The computing device is configured to perform the spectral analysis on the one or more electrical signals and send the spectral analysis to the spectrometer over the communications channel where the results are displayed for the user.

In alternative embodiments, the spectrometer can also include a standardization material positioned to receive X-rays from the pyroelectric radiation source during each individual test performed by the spectrometer. The detector is positioned to simultaneously receive secondary X-rays emitted from the standardization material and from the sample. The standardization material can include a single element such as, for example a Rare Earth element, or a combination of elements such as, for example, stainless steel.

In other alternative embodiments, the spectrometer can also include a plurality of radiation sources in a variety of shapes and sizes to maximize either power of flux to the sample. The plurality of radiation sources can be operated out of sync to maintain a more consistent X-ray flux to the sample.

In another aspect according to the present invention, a spectrometer includes a hand-holdable housing within which is included a source, a standardization material, a detector and a module, the source configured to direct electromagnetic energy toward a sample to be analyzed, the standardization material positioned to receive electromagnetic energy from the source, the detector for receiving secondary electromagnetic energy emitted from the sample and the standardization material, the detector configured to convert the secondary electromagnetic energy into one or more electrical signals, the module configured to receive the one or more electrical signals and send a representation of the one or more electrical signals over a communication channel to a remote computing device without performing any spectral analysis on the one or more electrical signals, the remote computing device configured to perform spectral analysis on the one or more electrical signals and send the spectral analysis to the spectrometer over the communications channel.

In alternative embodiments, the electromagnetic energy emitted from the source includes X-rays and the detector is configured to receive secondary X-rays from the sample. Optionally, the spectrometer includes a plurality of X-ray sources in a variety of shapes and sizes that can be operated in sync or out of sync to either maximize flux to the sample, or maintain a more consistent X-ray flux to the sample. The source can include a window through which the X-rays can pass made from beryllium or other X-ray transmissive material such as, for example, X-ray transmissive glass.

In further alternative embodiments, the spectrometer can include a memory device to store a plurality of sample tests, and/or an output display for displaying the spectral analysis of the sample.

In yet another aspect of the present invention, a method of analyzing a sample includes positioning a portable spectrometer adjacent the sample to be analyzed, the portable spectrometer comprising a hand-holdable housing within which is included a source, a standardization material, and a detector, the source comprising a radiation source for directing X-rays toward the sample to be analyzed, the standardization material positioned to receive X-rays from the radiation source, the detector for receiving secondary X-rays emitted from the sample and the standardization material, the detector configured to convert the secondary X-rays into one or more electrical signals; transmitting a representation of the one or more signals over a communication channel to a remote computing device, the remote computing device configured to perform spectral analysis on the one or more electrical signals; receiving the spectral analysis over the communications channel; and displaying the spectral analysis of the sample to a user.

In alternative embodiments, the transmission of the representation of the one or more signals over a communication channel is wireless and/or with cellular or Short Message Service (SMS) technology. Optionally, the spectrometer can include a memory device to store a plurality of sample tests.

In yet still another aspect of the present invention, a handheld X-ray fluorescence spectrometer includes a pyroelectric radiation source for directing X-rays toward a sample to be analyzed, a standardization material positioned to receive X-rays from the pyroelectric radiation source, and a detector for receiving secondary X-rays emitted from the sample and the standardization material and converting the secondary X-rays into one or more electrical signals representative of the received secondary X-rays.

In alternative embodiments, the spectrometer also includes a module configured to receive the one or more electrical signals and send a representation of the one or more electrical signals over a communication channel to a computing device without performing any spectral analysis on the one or more electrical signals to characterize the sample, the computing device being configured to perform spectral analysis on the one or more electrical signals and send the spectral analysis to the spectrometer over the communications channel.

In various alternative embodiments of the present invention, the pyroelectric radiation source can be lithium tantalite or lithium niobate, the radiation source can be substantially cylindrical, prismatic, or rhomboidal, and the detector can be a silicon pin detector, a silicon drift detector, or a proportional counter.

### BRIEF DESCRIPTION OF THE DRAWINGS

A fuller understanding of the aspects, objects, features, and advantages of certain embodiments according to the invention will be obtained and understood from the following description when read together with the accompanying drawings, which primarily illustrate the principles of the invention and embodiments thereof. The drawings are not necessarily to scale and like reference characters denote corresponding or related parts throughout the several views. The drawings and the disclosed embodiments of the invention are exemplary only and not limiting on the invention.

FIG. 1 is a schematic diagram of the general components of an elemental analysis apparatus according to one exemplary embodiment of the present invention.

FIG. 2 is a block diagram showing a hardware configuration of a computer machine.

FIG. 3 is a rear perspective view of a handheld spectrometer according to one exemplary embodiment of the present invention.

FIG. 4 is a front perspective view of the handheld spectrometer shown in FIG. 3.

FIG. 5 is a cut-away top view of the handheld spectrometer shown in FIG. 3.

FIG. 6 is a cross-sectional side view of the handheld spectrometer shown in FIG. 3 taken along the line 6-6 in FIG. 5.

FIG. 7 is an enlarged cross-sectional side view of an electromagnetic energy source for use in the handheld spectrometer shown in FIG. 3.

FIG. 8 is an enlarged view of the front portion of the handheld spectrometer shown in FIG. 5.

FIG. 9 is a schematic showing two alternative geometric shapes of a pyroelectric crystal for use in the handheld spectrometer shown in FIG. 3.

FIG. 10 is a schematic side view of the two alternative geometric shapes of a pyroelectric crystal shown in FIG. 9.

FIG. 11 is a schematic of a handheld spectrometer according to a second exemplary embodiment of the present invention.

FIG. 12 is a cut-away view of the handheld spectrometer shown in FIG. 11.

### DESCRIPTION

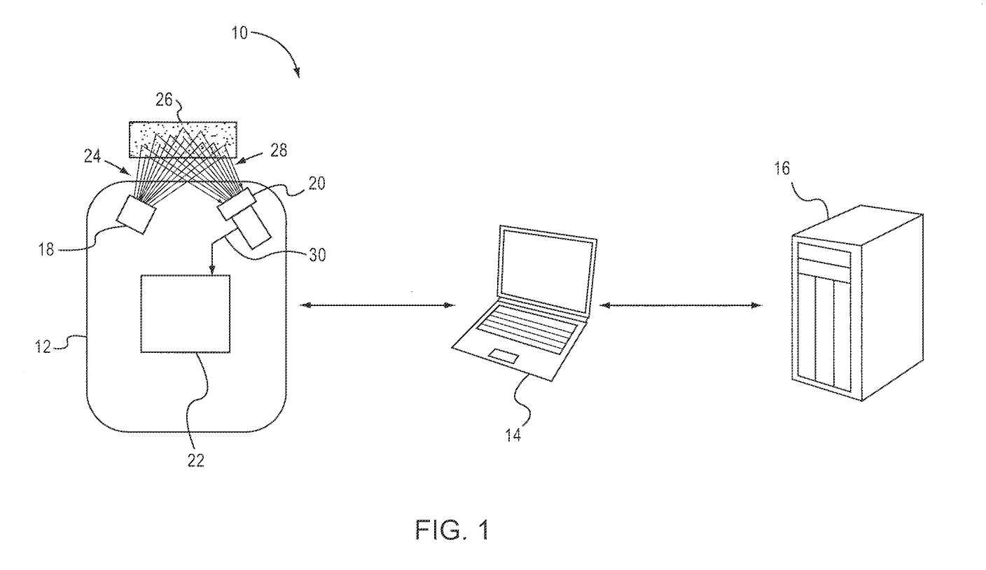

As indicated above, the present invention relates to the field of spectroscopy including X-ray fluorescence (XRF) spectroscopy and performing elemental analysis using a handheld XRF Spectrometer. FIG. 1 is a schematic diagram of the general components of an elemental analysis system 10 according to one exemplary embodiment of the present invention. The system 10 includes a handheld spectrometer 12, a communication device 14, and an analysis server 16. The spectrometer 12 includes an electromagnetic energy source 18, a detector 20, and a signal processing module 22. As shown in FIG. 1, the electromagnetic energy source 18 is a pyroelectric crystal that directs a primary beam of X-rays 24 towards a sample 26 to be analyzed. In an alternative exemplary embodiment, the electromagnetic energy source 18 is a radioactive isotope, which projects a primary beam of gamma rays towards the sample 26. In yet another exemplary embodiment, the electromagnetic energy source 18 is an electron beam source that projects a primary beam of electrons towards the sample 26. Any suitable electromagnetic energy source, or plurality of sources can be used as the electromagnetic energy source 18.

After the primary beam of X-rays 24 hits the sample 26, the sample 26 becomes excited and emits new, wholly different X-rays. These secondary or responsive X-rays 28 (sometimes referred to as fluorescent X-rays) are collected by the detector 20, and are particular to each element (i.e., they have a unique energy or set of energies, characteristic of the element impinged by the original or primary X-rays 24). The detector 20 includes electronic circuitry that converts collected X-rays 28 to one or more electrical signals 30 and transmits the signal 30 to the signal processing module 22. The signal processing module 22 includes electronic circuitry that enables transmission of data to and from the communications device 14. While described herein as a multi-component, non-handheld unit, one of more of the components of elemental analysis system 10 can be combined into a stationary bench-top unit, a portable bench-top unit, or a portable handheld analyzer. One or more of the component parts can also be separate units interconnected using a variety of known wired or wireless technologies.

The spectrometer 12 communicates with the analysis server 16 via the communication device 14. The communication device 14 can be a desktop computer, a laptop computer, a tablet PC, a Netbook®, or a portable computing device such as, for example, a cellular telephone, Blackberry®, Personal Data Assistant (PDA) or any other type of computing device that can access a communications network. In this embodiment where the communication device 14 is separate from the spectrometer 12, the communication device 14 can also sort the electrical signals 30 into channels on the basis of their energy level, creating the spectra for the analysis server to analyze (e.g., the function of a multi-channel analyzer). This can be accomplished by including an additional software program in the communication device 14 rather than adding additional hardware or software to the spectrometer 12.

The spectrometer 12 or communication device 14 can also include a control function that allows users to input settings and manage other components in the system 10. For example, the spectrometer 12 device can include a keyboard or touch screen to provide inputs, manage test options, read test results, and/or launch and control tests. Alternatively, if the communication device is, for example, a laptop computer, the control function can be performed using the keyboard, touch screen, and/or mouse on the laptop computer.

By way of example, in one implementation where the communication device 14 is a stand-alone device such as, a laptop computer with access to the Internet, the user accesses a website on the World Wide Web and downloads a driver to the laptop computer to allow the communications device 14 to perform the function of a multi-channel analyzer, or even as an analysis server 16. In addition, the user can use the communications device 14 to access test results and/or to control the spectrometer 12. The user can also access multiple devices or test results from multiple devices associated with the analysis server 16. The test results can be presented in a variety of formats and can be compared across various spectrometers 12.

Typically the analysis server 16 is a general purpose computer configured to execute analysis and management software. The analysis server 16 receives the test data from the spectrometer 12 via the communication device 14, either in real time, or delayed, depending on whether the user is connected (e.g., hardwired or wireless) to the analysis server. The analysis server 16 then executes the analysis and management software, which analyzes the data and spectra provided by the spectrometer 12 to determine the elemental make-up of the tested sample.

In one example, access to the analysis server 16 and analysis software is provided as a service, and the analysis server 16 and software are owned and maintained by the system 10 manufacturer or by another third party other than the user of the spectrometer 12. This centralization of the analysis server 16 and software provides strict quality control and allows for the software to be easily updated. The system 10 manufacturer can then charge individual customers for use of their software, either by period of time (e.g., monthly or annually), by test, by block of tests, or by other variable or non-variable means of purchasing access, rather than selling the software and/or hardware for ownership by the user.

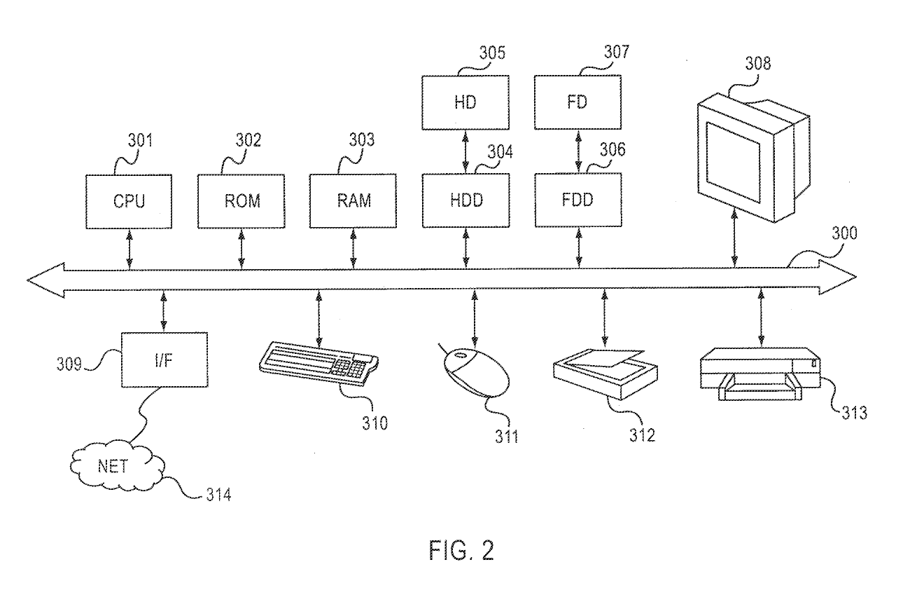

FIG. 2 is a block diagram showing a hardware configuration of a computer machine for use in the elemental analysis system 10 shown in FIG. 1. The computer machine includes a CPU 301, a ROM 302, a RAM 303, a HDD (hard disk drive) 304, a HD (hard disk) 305, a FDD (flexible disk drive) 306, a FD (flexible disk) 307, which is an example of a removable recording medium, a display 308, an I/F (interface) 309, a keyboard 310, a mouse 311, a scanner 312 and a printer 313. These components are respectively connected via a bus 300 and are used to execute computer programs described herein.

Here, the CPU 301 controls the entire computer machine. The ROM 302 stores a program such as a boot program. The RAM 303 is used as a work area for the CPU 301. The HDD 304 controls the reading/writing of data from/to the HD 305 under the control of the CPU 301. The HD 305 stores the data written under the control of the HDD 304. The FDD 306 controls the reading/writing of data from/to the FD 307 under the control of the FDD 306. The FD 307 stores the data written under the control of the FDD 306 or causes the computer machine to read the data stored in the FD 307.

The removable recording medium may be a CD-ROM (CD-R or CD-RW), an MO, a DVD (Digital Versatile Disk), a memory card or the like instead of the FD 307. The display 308 displays data such as a document or an image, and functional information, including a cursor, an icon and/or a toolbox, for example. The display 308 may be a CRT, a TFT liquid crystal display, or a plasma display, for example.

The I/F 309 is connected to the network 314 such as the Internet via a communication line and is connected to other machines over the network 314. The I/F 309 takes charge of an internal interface with the network 314 and controls the input/output of data from/to an external machine. A modem or a LAN adapter, for example, may be adopted as the I/F 309.

The keyboard 310 includes keys for inputting letters, numbers and commands and is used to input data. The keyboard 310 may be a touch-panel input pad or a numerical keypad. The mouse 311 is used to move a cursor to select a range to move or change the size of a window. A trackball or joystick, for example, may be used as a pointing device if it has the same functions.

The scanner 312 optically scans an image and captures the image data into the computer machine. Notably, the scanner 312 may have an OCR function. The printer 313 prints image data and/or text data. A laser printer or an ink-jet printer, for example, may be adopted as the printer 313.

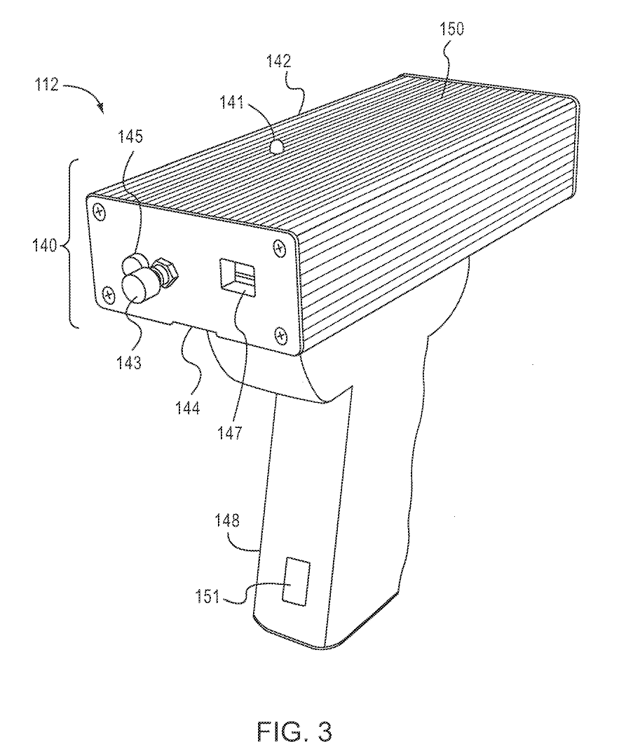

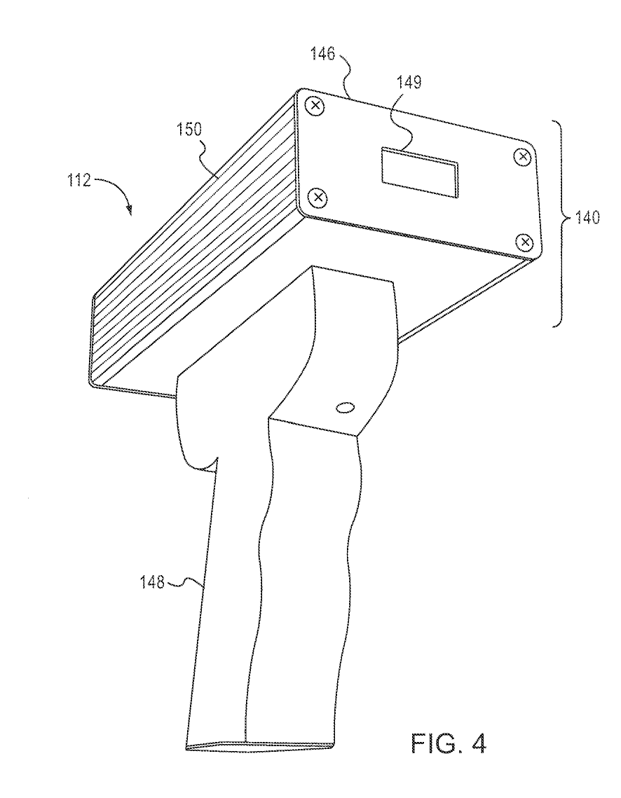

FIGS. 3 and 4 are perspective views of an exemplary embodiment of a handheld XRF spectrometer 112 for use in the elemental analysis system 10. The handheld XRF spectrometer 112 includes a housing 140 that encloses and protects the internal assemblies of the spectrometer 112. The housing 140 includes a main body 142 and two end pieces 144, 146. The main body 142 can be one piece or made from multiple pieces connected together with a variety of mechanical and/or chemical fasteners including, for example, screws, welds, or adhesives. The housing 140 includes a test active indicator light 141 (FIG. 3), and end piece 144 includes system on/off switch 143, a system on/off light 145, and a USB port 147. The front end piece 146 includes an aperture 149 that enables the primary X-rays to pass outside the housing to reach a sample, and the fluorescent secondary X-rays to return to the detector inside the housing. The aperture 149 can either be an opening in the housing or can be an X-ray transmissive material such as, for example, a polyimide film sold under the trade name Kapton® or beryllium, to protect the internal components of the spectrometer.

In one exemplary embodiment, the XRF spectrometer 112 includes a handle 148 extending from the main body 142 of the housing 140. The handle 148 may be positioned such that the user may comfortably hold handle 148 and direct the aperture 149 to the desired position adjacent a sample to be analyzed. The handle 148 also includes a battery charging port 151 to allow an internal power source to be recharged as needed.

The housing 140 and the handle 148 can be made from a variety or materials such as, for example, aluminum, titanium, alloys, plastics, polymers, resins, or combinations thereof, such as, for example, polycarbonate, polyethylene, or polypropylene. The housing 140 protects the internal assemblies of handheld XRF spectrometer 112, therefore, the housing material should be lightweight, inexpensive, resistant to corrosion, and have thermal transfer capability. This protection may include, but is not limited to, protection from elements such as wind and rain, and protection from dust and other impurities. The housing material should also be capable of surviving shock, vibration, and drop conditions, without any puncturing or internal component dismantling. This protection may also be bolstered through the use of over molding, rubber bumpers, shock absorbing mounts internal to the instrument assembly, and/or the use of crushable impact guards.

As shown, the housing 140 includes a plurality of ribs 150 formed on the outer surface of the main body 142. The ribs 150 add structural integrity to the housing 140 and can enhance the thermal transfer capability of the housing 140. The housing 140 and handle 148 can be injection molded from a high density polyethylene (HDPE) thermoplastic or similar materials. The injection molding process provides many advantages over other manufacturing methods including, for example, low cost, consistency of parts, scalability, and versatility of design and materials. With the use of modern computerized machining equipment, molds are relatively inexpensive to make and the use of interchangeable inserts and subassemblies, one mold can be used to may make several variations of the same part. This flexibility allows the housing 140 to be easily scaled to accommodate different sized spectrometer components.

Some molds allow previously molded parts to be reinserted to allow a new plastic layer to form around the first part. This is often referred to as overmolding. This can be achieved by having pairs of identical cores and pairs of different cavities within the mold. After injection of the first material, the component is rotated on the core from the one cavity to another. The second cavity differs from the first in that the detail for the second material is included. The second material is then injected into the additional cavity detail before the completed part is ejected from the mold. This overmolding process can also allow for inserts to be placed between the first and second material to assist with heat dissipation.

The spectrometer 112 can be operated in the general proximity of an analysis server, or geographically remote from the analysis server. In addition, more than one spectrometer 112 can be in communication with the analysis server at the same time, thereby allowing multiple users to analyze a plurality of samples in any number of geographic locations. When the analysis server is in communication with multiple spectrometers 112, the test data associated with each individual sample/spectrometer 112 are analyzed individually by the analysis server, utilizing the stored calibration and other information particular to the individual spectrometer 112 in use for a particular test. After the analysis is performed by the server, the test results are available to the user of the spectrometer via a display device on the spectrometer 112. In addition, the test results can be made available to any authorized user with access to the elemental analysis system 10 via an electronic communications network, for example, a Local Area Network or Wide Area Network such as the Internet. Other types of networks suitable for communications such as, for example, a Personal Area Network, a Campus Area Network, and/or a Metropolitan Area Network are possible alternative communications networks. Authorized users of the system 10 can also track results over time, generate reports, and compare spectral charts/results among various locations and various spectrometers 112.

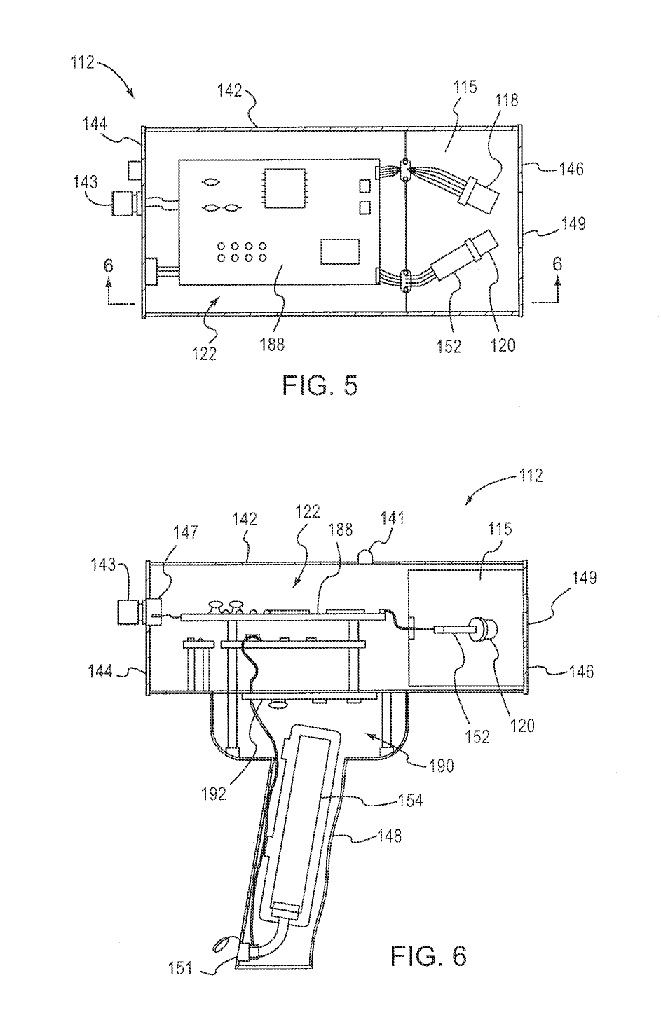

Referring now to FIGS. 5 and 6, the internal components of the spectrometer 112 are shown. The spectrometer 112 includes an electromagnetic energy source 118 (FIG. 5), a detector 120, a pre-amplifier 152, a signal processing module 122, and a power source 154 (FIG. 6) encased in the housing 140 and/or handle 148. As shown, the source 118, the detector 120, and the pre-amplifier 152 are isolated in a separate compartment 115 within the housing. In certain embodiments, the compartment 115 can be maintained at a vacuum to enable detection of lighter elements such as, for example, magnesium (Mg) and Aluminum (Al). The electromagnetic energy source 118 can be a source of radiation, X-rays, or electrons, depending on the type of spectrometer 112. For example, the source 118 can be a traditional X-ray tube such as the Mini-X available from Amptek, Inc. in Bedford, Mass., a radioactive isotope such as, for example, Cd¹⁰⁹, Co⁵⁷, and Fe⁵⁵, or a non-traditional pyroelectric X-ray source such as COOL-X available from Amptek, Inc. in Bedford, Mass. The source 118 is chosen for its ability to induce fluorescence in the particular elements of interest in the sample.

In one exemplary embodiment, the source 118 is one or more pyroelectric crystals which are heated and cooled to generate electrons. Pyroelectric crystals exhibit spontaneous decrease of polarization when they are heated and a spontaneous increase of polarization when they are cooled. Therefore, as the temperature of the crystal increases, an electric field develops across the crystal and one surface of the crystal becomes positively charged and attracts electrons from the atmosphere. As the electrons impinge on the surface of the crystal, they produce characteristic X-rays as well as Bremsstrahlung X-rays. When the cooling phase starts, the spontaneous polarization increases, and the electrons from the top surface of the crystal are accelerated toward a target which is at ground potential. During this phase of the heating/cooling cycle, characteristic X-rays of the target as well as Bremsstrahlung X-rays are produced. When the crystal temperature reaches its low point, the heating phase starts again. Because of this thermal cycling, the pyroelectric X-ray source 118 does not produce a constant flux of X-rays. The X-ray flux varies throughout the cycle and may vary from cycle to cycle.

The detector 120 is positioned to receive the secondary X-rays that are being emitted from the sample. The detector 120 converts the incoming fluoresced X-ray photons to analog electrical pulses, which can be amplified by the pre-amplifier 152 prior to counting. For example, the detector 120 can be a Si-PIN detector such as the XR-CR100, a silicon drift detector such as the XR-100SDD, both available from Amptek, Inc. in Bedford, Mass., or a proportional counter. The detector 120 is chosen depending on the particular elements of interest in the sample. Some detectors 120, including, for example, the XR-CR100 Si-PIN detector includes a built-in pre-amplifier 152. Alternatively, a pre-amplifier may be added to the system separately, or excluded all together if the other components in the system do not require it.

The signal processing module includes a multi-channel analyzer (MCA) 188, sometimes referred to as a pulse processor, which converts analog pulses from the detector 120 or pre-amplifier 152 to a digital signal, and optionally, can also count them into channels. A channel is one range of electron energy, for example, one two thousandth of the total range of possible fluoresced X-ray energies. One example of a multi-channel analyzer (MCA) 188 is the MCA 8000A, available from Amptek, Inc. in Bedford, Mass.

A power management system 190 can be included to enable remote operation when the spectrometer 112 is not physically connected to the communications device 14 (e.g., a laptop computer) or when the communications device 14 is included in the spectrometer 112. The power management system 190 includes a power source 154 such as, for example, a nickel metal hydride battery, a power management circuit board 192, and a battery charging port 151.

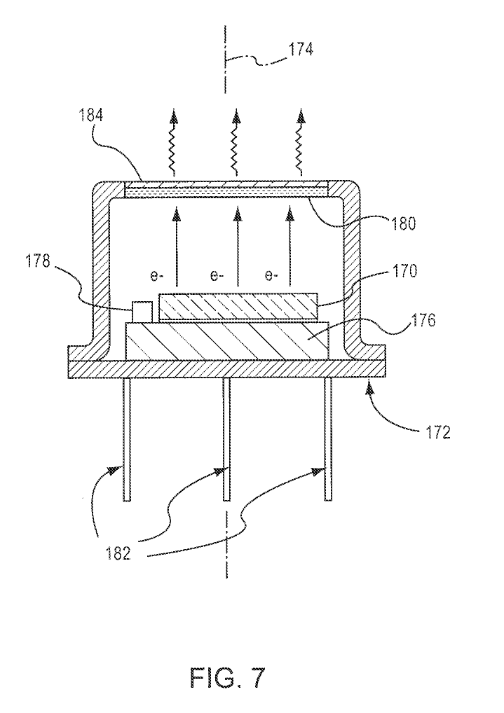

Referring now to FIG. 7 a pyroelectric crystal 170 is shown mounted in a case 172 and thermally coupled to a thermal control unit 176 with conductive adhesive. In one embodiment, the thermal control unit 176 is a flat resistor of not less than 100Ω and a thermocouple 178 to measure temperature and provide feedback to the thermal control unit 176. A target 180 is spaced a predetermined distance away from the crystal 170 and aligned along the z-axis 174 such that electrons produced by the thermal cycling of the crystal 170, which are produced almost exclusively along the z-axis 174, impinge on the target 180 thereby generating X-rays which are emitted from the source 118.

The crystal 170 and the target 180 are maintained in a vacuum of approximately 10⁻³ Torr or less by the case 172. In one embodiment, the case 172 is a glass enclosure similar to that used for vacuum tubes. Alternatively a metal housing can by used to form the case 172. Electrical connections 182 extend from the crystal 170 and thermal control unit 176 to the outside of the case 172 to allow operation, control, and measurements of the status of components inside the case 172. The target 180 can be attached to the case 172, or it can be supported structurally by a wire or other mounting device or method such that it is substantially aligned along the z-axis 174 of the crystal 170. A target 180 can be made from a variety of material such as, for example, copper (Cu) or tantalum (Ta). Since the target 180 emits characteristic X-rays depending on the material used, the target 180 material can be changed depending on the type of sample to be analyzed or elements of interest in the sample. Optionally, a beryllium or similarly X-ray transparent window 184 may be inserted to reduce losses of X-ray flux leaving the X-ray source. For example, in one embodiment, the X-ray transparent window 184 is an X-ray transmissive glass.

In operation, the user initiates a test by placing the spectrometer 112 adjacent a sample to be analyzed such that the aperture 149 of the housing 142 is near the sample. In an alternative embodiment where the spectrometer is a “closed beam” spectrometer, the sample is placed inside a test chamber. As described above, the user can optionally set any preferred parameters depending on the sample to be analyzed, and then after complying with appropriate safety procedures, the test is initiated via a hardware and/or software start button.

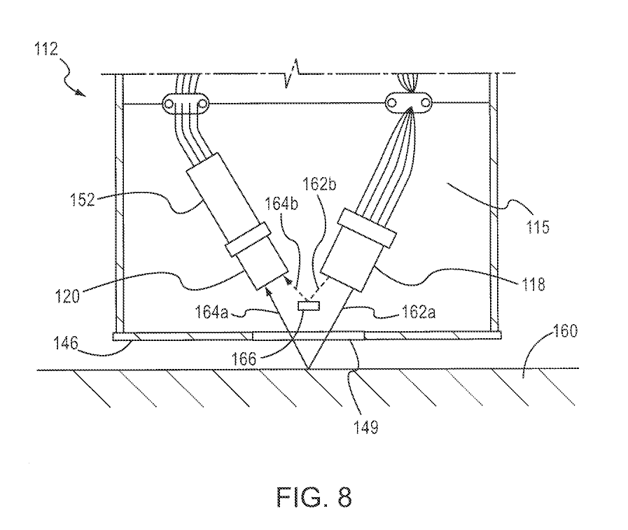

Referring now to FIG. 8, the front portion of the spectrometer 112 is shown adjacent a sample 160 to be analyzed. When the test is initiated, the source emits a stream of primary X-rays 162a or electrons that pass through the aperture 149 and impinge on the sample 160. As described above, individual elements within the sample absorb these photons, and respond via one of several known atomic processes.

One of these known processes is X-ray fluorescence, in which the impinging X-ray is described as knocking an electron out of an inner orbit, and an outer electron, which exists at a higher energy state, jumping to the lower energy state of the now-vacant inner shell. To fit into the lower energy state, that jumping electron must give up the energy difference between its old higher energy state and its new, lower energy state. That energy is generally carried away from the electron in the form of an X-ray photon, whose total energy is exactly that of the energy difference between the old and new states of the electron. The detector 120 is positioned to receive the secondary X-rays 164a that are being emitted from the sample 160. As described above, the detector 120 converts the incoming fluoresced X-ray photons to analog electrical pulses, which can be amplified by a pre-amplifier 152 prior to counting.

There are a limited number of possible electron transitions within each element, and each always carries the same quantity of energy. The energy differences in energy state are specific to each element, and therefore the energy of each emitted X-ray is characteristic of that element. By analyzing the energy in an emitted photon, we can know what element gave off that particular X-ray. By analyzing the number of electrons at each of those energy levels, we can know how much of each element is present in the sample.

In one embodiment, the spectrometer includes a standardization material 166 mounted in the path of the X-ray stream 162b being emitted from the source 118. The standardization material 166 is positioned such that some, but not all, of the X-rays 162b emanating from the source 118 will impinge on the standardization material 166 and then some of the X-rays 164b fluoresced from the standardization material 166 will be received by the detector 120 and counted.

The standardization material 166 can be any of a variety of shapes and can be made from one specific element, or more than one element of known composition (e.g., stainless steel). The inclusion of the standardization material 166 provides the system 10 with a scalable standard on each test, such that the accuracy of each test result may be improved by comparison with the known energy and quantity of photons emitted by that standardization material 166. For example, the stream of X-rays from a pyroelectric crystal X-ray source can vary from one test to the next, therefore the standardization material 166 allows the system 10 to make adjustments due to inconsistencies in the system. Other variables that can affect the system performance from test to test include, for example, temperature, air pressure, and humidity.

The standardization material 166 can be selected to fluoresce at energies that are unlikely to be found in the samples which are the intended elements to be studied. Additionally, the element or elements can be chosen to have more than one peak in the analyzed region of the spectrum, so that relative value of more than one point on the calibration curve can be included in the analysis, to increase accuracy across the region of interest in the energy spectrum. For example, the use of a Rare Earth element such as Yttrium and/or Ytterbium, with characteristic energy signature that do not overlap with the elements intended to be measured.

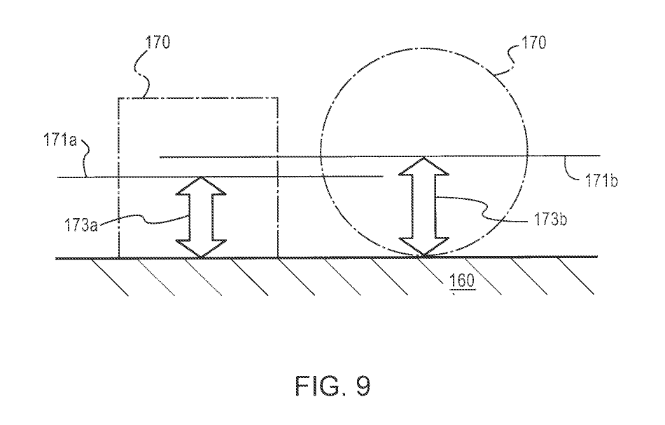

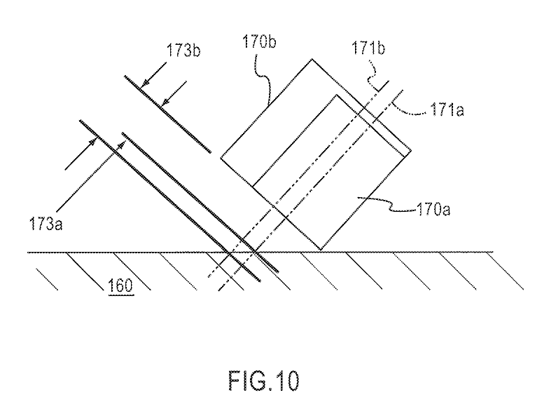

Referring now to FIGS. 9 and 10, the pyroelectric crystal source 170 can be any of a variety of shapes including, for example, cylindrical, rectangular, rhomboidal, cubic or rectangular cubic. The strength of the X-rays emitted from the source diminishes as the distance from the source 170 increases according to the inverse square law. This changes the total X-ray flux non-linearly as measured by the equivalent axial center. For example, two alternative embodiments of equal area X-ray sources are shown. The first source 170a is rectangular and has a centerline 171a a first distance 173a away from the sample 160. The second source 170b is cylindrical and has a centerline 171b a second distance 173b away from the sample 160 (see FIG. 9). Because the first distance 173a is shorter than the second distance 173b, the net center of the flux source is closer to the sample and the detector.

In another alternative embodiment, the source includes a plurality of individual sources to increase the net flux to the sample. As described above with respect to pyroelectric X-ray sources, the X-ray flux from the source varies over time as the source is thermally cycled and can also vary from one thermal cycle to the next. In this embodiment, by using a plurality of sources that are operated out of sync (i.e., not synchronized in time), a more consistent X-ray flux can be achieved.

In yet another embodiment, a filter can be placed in front of the source such that is it movable to optimize the energy or other parameters of the X-rays impinging on the sample. The filter can be, for example, a wheel or disk mounted to the front of the spectrometer with a variety of filter materials placed at various radial locations around the disk such that as the disk is rotated, a different filter material is positioned in between the sample and the source. The filter can be rotated manually, or can be motorized. In another embodiment, this filter can be a linear array of filter materials and can be slidable with respect to the spectrometer (e.g., manually or motorized) to position a different filter material between the sample and the source.

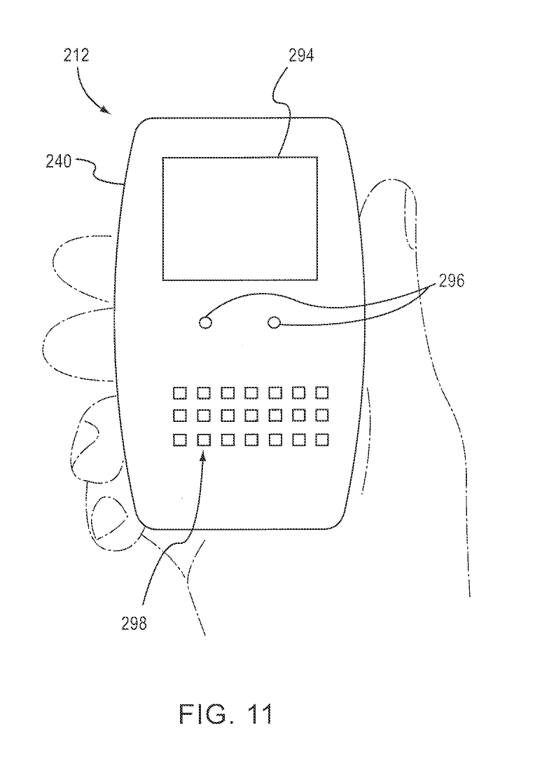

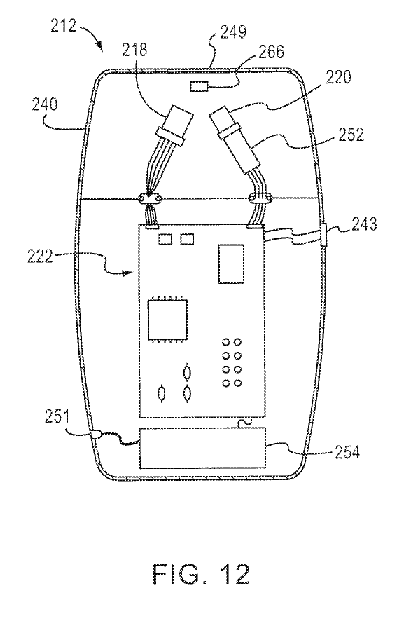

FIGS. 11 and 12 show an alternative embodiment of a handheld spectrometer 212 for use with an elemental analysis system 10 of the present invention. The handheld spectrometer 212 is similar in size and shape to a Personal Data Assistant (PDA) or a Blackberry®. The handheld spectrometer 212 performs substantially the same function as the spectrometer 112 described above, and therefore like reference numerals preceded by the numeral “2” are used to indicate like elements. In this embodiment, the communications device is integral to the spectrometer 212, which allows the spectrometer 212 to communicate with the remote analysis server 16 via a Wide Area Network (e.g., the Internet), cellular technology, Short Message Service (SMS) technology, Multimedia Messaging Service (MMS) technology, Bluetooth®, or any other of a variety of wired or wireless technology is used to communicate with the remote analysis server 16. The spectrometer 212 includes a housing 240 to protect the internal components. The housing 240 includes an on/off switch 243, an aperture 249 that enables the primary X-rays to pass outside the housing to reach a sample, and the fluorescent secondary X-rays to return to the detector inside the housing 240 and one or more output displays 294, 296 to display the test results to the user. The output display can be a display screen 294 or individual indicator lights 296 for representing a positive or negative test results (i.e., the presence or absence of a specific element in the sample), for example, green light for positive and red light for negative.

FIG. 12 illustrates the internal components of the spectrometer 212. The spectrometer 212 includes an electromagnetic energy source 218, a detector 220, a pre-amplifier 252, a signal processing module 222, a power module 254 encased in a housing 240, and a battery charging port 251. The electromagnetic energy source 218 can be a source of radiation, X-rays, or electrons depending on the type of spectrometer 212. For example, the source 218 can be a pyroelectric X-ray source such as COOL-X available from Amptek, Inc. in Bedford, Mass. described above. The source 218 is chosen for its ability to induce fluorescence in the particular elements of interest in the sample.

The detector 220 is positioned to receive the secondary X-rays that are being emitted from the sample. The detector 220 converts the incoming fluoresced X-ray photons to analog electrical pulses, which can be amplified by a pre-amplifier 252 prior to counting. For example, the detector 220 can be a Si-PIN detector such as the XR-CR100 available from Amptek, Inc. in Bedford, Mass. as described above. The detector 220 is chosen depending on the particular elements of interest in the sample. Some detectors 220, including, for example, the XR-CR100 Si-PIN detector includes a built-in pre-amplifier 252.

A signal processing and communications module 222 converts the analog pulses from the detector 220 or pre-amplifier 252 to a digital signal, and transmits a representation of the signal over a communication channel to the remote analysis server 16. The communications channel may be for example, a Wide Area Network (e.g., the Internet) or cellular technology as described above. A power management system 290 can be included to enable remote operation when the spectrometer 212 is not physically connected to a separate communications device 14 (e.g., a laptop computer).

In operation, the user initiates a test by placing the spectrometer 212 adjacent a sample to be analyzed such that the aperture 249 of the 240 housing is near the sample. The user can optionally enter any preferred parameters depending on the sample to be analyzed using an input device such as, for example, a keyboard 298 (FIG. 11) or a touch screen, and then after complying with appropriate safety procedures, the test is initiated via the on/off switch 243.

When the test is initiated, the source emits a stream of X-rays, some of which impinge on the standardization material 266 while the bulk of the X-rays pass through the aperture 249 and impinge on the sample. The detector 220 is positioned to receive the secondary X-rays that are being emitted from the standardization material 266 and the sample. The detector 220 converts the incoming fluoresced X-ray photons to analog electrical pulses, which are then amplified by a pre-amplifier 252. The signal processing and communication module 222 communicates with the analysis server 16, or alternatively, if the spectrometer 212 is unable to communicate with the analysis server 16, the spectrometer 212 can store one or more sample tests on a memory storage device (not shown) in the spectrometer 212. Once the analysis server 16 receives the test data from the spectrometer 212, either in real time or time delayed, depending on the user's access/connectivity to the analysis server 16, the server 16 analyzes the data and spectra provided by the spectrometer 212 to determine the elemental make-up of the tested sample. After the analysis is complete, the results are communicated back to the spectrometer 212 via the communications channel and are displayed to the user on the output display 294, 296.

The disclosed embodiments are exemplary. The invention is not limited by or only to the disclosed exemplary embodiments. Also, various changes to and combinations of the disclosed exemplary embodiments are possible and within this disclosure. Those skilled in the art will recognize, or be able to ascertain using no more than routine experimentation, many equivalents of the specific embodiments of the invention described herein. Such equivalents are intended to be encompassed by the following claims.

What is claimed is:

1. A handheld X-ray fluorescence spectrometer comprising:
a pyroelectric radiation source for directing X-rays toward a sample to be analyzed;
a detector for receiving secondary X-rays emitted from the sample and converting the secondary X-rays into one or more electrical signals representative of the received secondary X-rays;
a module configured to receive the one or more electrical signals and send a representation of the one or more signals over a communication channel to a computing device without performing any spectral analysis on the one or more electrical signals to characterize the sample, the computing device configured to perform spectral analysis on the one or more electrical signals and send the spectral analysis to the spectrometer over the communications channel; and
an output display for displaying the spectral analysis.

2. The spectrometer of claim 1, further comprising a standardization material positioned to receive X-rays from the pyroelectric radiation source.

3. The spectrometer of claim 2, wherein the detector receives secondary X-rays emitted from the standardization material.

4. The spectrometer of claim 2, wherein the standardization material comprises a rare earth element.

5. The spectrometer of claim 4, wherein the standardization material is at least one of Yttrium and Ytterbium.

6. The spectrometer of claim 1, further comprising a plurality of radiation sources.

7. The spectrometer of claim 6, wherein the plurality of radiation sources are operated such that the X-ray flux emissions are not synchronized in time.

8. The spectrometer of claim 1, further comprising a data storage device for storing data representative of the one or more electrical signals.

9. A spectrometer comprising:
a hand-holdable housing within which is included a source, a standardization material, a detector and a module, the source configured to electromagnetic energy toward a sample to be analyzed, the standardization material positioned to receive electromagnetic energy from the source, the detector for receiving secondary electromagnetic energy emitted from the sample and the standardization material, the detector configured to convert the secondary electromagnetic energy into one or more electrical signals, the module configured to receive the one or more electrical signals and send a representation of the one or more electrical signals over a communication channel to a remote computing device without performing any spectral analysis on the one or more electrical signals, the remote computing device configured to perform spectral analysis on the one or more electrical signals and send the spectral analysis to the spectrometer over the communications channel.

10. The spectrometer of claim 9, wherein the electromagnetic energy emitted from the source includes X-rays.

11. The spectrometer of claim 10, wherein the detector is configured to receive secondary X-rays from the sample.

12. The spectrometer of claim 11, wherein the source includes a window through which the X-rays can pass.

13. The spectrometer of claim 12, wherein the window is X-ray transmissive glass.

14. The spectrometer of claim 9 further comprising an output display for displaying the spectral analysis of the sample.

15. The spectrometer of claim 9 further comprising a plurality of sources.

16. The spectrometer of claim 15, wherein the sources are operated such that the electromagnetic energy emitted from the plurality sources are not synchronized in time.

17. A method of analyzing a sample comprising:
positioning a portable spectrometer adjacent the sample to be analyzed, the portable spectrometer comprising a hand-holdable housing within which is included a source, a standardization material, and a detector, the source comprising a radiation source for directing X-rays toward the sample to be analyzed, the standardization material positioned to receive X-rays from the radiation source, the detector for receiving secondary X-rays emitted from the sample and the standardization material, the detector configured to convert the secondary X-rays into one or more electrical signals;
transmitting a representation of the one or more signals over a communication channel to a remote computing device, the remote computing device configured to perform spectral analysis on the one or more electrical signals;
receiving the spectral analysis over the communications channel; and
displaying the spectral analysis of the sample to a user.

18. The method of claim 17, wherein the data transmission is wireless.

19. The method of claim 18, wherein the data is transmitted with a Short Message Service (SMS).

20. The method of claim 17, further comprising storing the data representative of the one or more electrical signals on a data storage device in the portable spectrometer.
